(19) United States
(12) Patent Application Publication
(10) Pub. No.: US 2015/0371163 A1
(43) Pub. Date: Dec. 24, 2015

(54) CHURN PREDICTION IN A BROADBAND NETWORK

(71) Applicant: Adaptive Spectrum and Signal Alignment, Inc., Redwood City, CA (US)

(72) Inventors: Jeonghun NOH, Irvine, CA (US); Wooyul LEE, Palo Alto, CA (US); Manish AMDE, Redwood City, CA (US); George GINIS, San Mateo, CA (US); Youngsik KIM, Palo Alto, CA (US)

(73) Assignee: Adaptive Spectrum and Signal Alignment, Inc., Redwood City, CA (US)

(21) Appl. No.: 14/767,870

(22) PCT Filed: Feb. 12, 2014
(86) PCT No.: PCT/US2014/016118

§ 371 Date: Aug. 13, 2015

Related U.S. Application Data
(63) Continuation of application No. PCT/US2013/026236, filed on Feb. 14, 2013.

(51) Int. Cl. G06Q 10/06

(52) U.S. Cl. CPC G06Q 10/0635

(57) ABSTRACT

A churn predictor predicts whether a customer is likely to churn. The churn predictor is built and trained from data collected from multiple customers. The data can include static configuration data and dynamic measured data. A churn predictor builder generates multiple customer instances and processes the instances based on the collected data, and based on separating the instances into one or more training subsets. Based on the processing, the builder generates and saves a churn predictor. The churn predictor can access data for a customer and generate a customer instance for evaluation against the training data. The churn predictor processes the customer instance and generates a churn likelihood score. Based on a churn type, the churn predictor system can generate preventive action for the customer.

### CLAIM OF PRIORITY

This application is a U.S. National Phase Application of International Patent Application No. PCT/US2014/016118, filed Feb. 12, 2014, titled “CHURN PREDICTION IN A BROADBAND NETWORK,” and claims the benefit of priority of International Patent Application No. PCT/US2013/026236 filed Feb. 14, 2013, titled “CHURN PREDICTION IN A BROADBAND NETWORK,” the entire contents of which are hereby incorporated by reference herein.

### FIELD

Embodiments of the invention are generally related to networking, and more particularly to predicting customer churn in a broadband network.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2013, ASSIA, Inc., All Rights Reserved.

### BACKGROUND

Churn or service disconnect (which could also be referred to as customer turnover or attrition), continues to be a significant issue for broadband service providers, such as DSL (digital subscriber line) operators. Naturally, service providers and operators would like to reduce churn. However, there are many reasons a customer could decide to disconnect from broadband service. Reasons can include line stability, rates, quality of tech support, customer experience during the activation process, competing offers, or other reasons. Finding a hindsight correlation between one or a small number of these factors with historical churn is typically fairly easy. However, it is traditionally difficult to find out how the various factors systemically contribute to the churn of customers in a statistical sense.

While network operators typically have access to a great amount of historical data, it is not always clear what data to use, or how to interpret the data to predict future behavior of other customers. Additionally, while certain empirical data may be available for a churner, the disconnecting customers do not always provide an indication of their reason(s) for leaving. Thus, there may be a great deal of data available, and yet not a specific reason as to why a customer became dissatisfied.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system having a churn predictor that evaluates churn likelihood for customers.

FIG. 2A is a block diagram of an embodiment of a hierarchy of a churn predictor builder.

FIG. 2B is a block diagram of an embodiment of a churn predictor hierarchy.

FIG. 3A is a block diagram of an embodiment of a system to build a churn predictor.

FIG. 3B is a block diagram of an embodiment of a system to generate a churn prediction.

FIG. 4 is a block diagram of an embodiment of a data collection system used in churn prediction.

FIG. 5 is a block diagram of an embodiment of evaluating churn prediction of customers within a prediction window for building a churn predictor.

FIG. 6 is a block diagram of an embodiment of a system to generate churn prediction models based on churner and non-churner subset information.

FIG. 7 is a flow diagram of an embodiment of a process for building a churn predictor.

FIG. 8 is a flow diagram of an embodiment of a process for predicting customer churn with a churn predictor.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a system performs data collection on data related to customer churn to train and build a churn predictor. The data can include information about the physical layer broadband connection information. The data can include static data such as configuration data, as well as dynamic data such as measured data. The data can include data directly related to the broadband connection, metadata about the connection, or other data that can be used to identify why a customer would discontinue broadband service. The data can include data directly related to factors under the control of the service provider (e.g., network settings, including configuration of a specific line) as well as data about factors not under the control of the service provider (e.g., weather or environmental factors, economics, competitor behavior). Given the data, the system can train a model(s) with pattern(s) useful in predicting customer churn. As used herein, customer churn refers to a customer terminating service, and can also be referred to as customer turnover, customer attrition, or service disconnect.

A churn predictor builder generates multiple customer instances and processes the instances based on the collected data. In one embodiment, the churn predictor processes the multiple instances based on separating the instances into training subsets. Based on the processing, the builder generates and saves a churn predictor. A churn predictor predicts whether a customer is likely to churn by accessing data for a specific customer or group of customers and generating a customer instance for evaluation against the trained model(s). The churn predictor processes the customer instance and generates a churn likelihood score. Based on churn likelihood and churn type, the churn predictor system can generate remedial or preventive action for a customer.

In contrast to known systems, in one embodiment, the system described herein uses physical data obtained from monitoring networking devices. It will be understood that such data has a high dimensionality of input data, where the input data can include physical layer operational parameters and performance counters, as well as side information such as competing services in the same region where customers reside, call data, dispatch data, and technical support of the service provider. The system builds a churn predictor using machine learning, which allows the system to effectively manage the massive amounts of data.

In one embodiment, churn prediction can be separated into two separate activities. The first activity is to build a churn predictor. Building a churn predictor includes at least the following components: data collection, data preprocessing to prepare the input data for training the model(s), and a model builder that uses machine learning algorithms in a training process. The second activity is to evaluate customers with the trained model(s) to produce a churn likelihood prediction. Customer evaluation includes at least the following components: data collection to obtain data for the target customer(s) being evaluated, data preprocessing, and prediction using the churn predictor. In one embodiment, customer processing includes selecting a subset of customers that are most likely to churn, and generating preventive actions for that subset of customers.

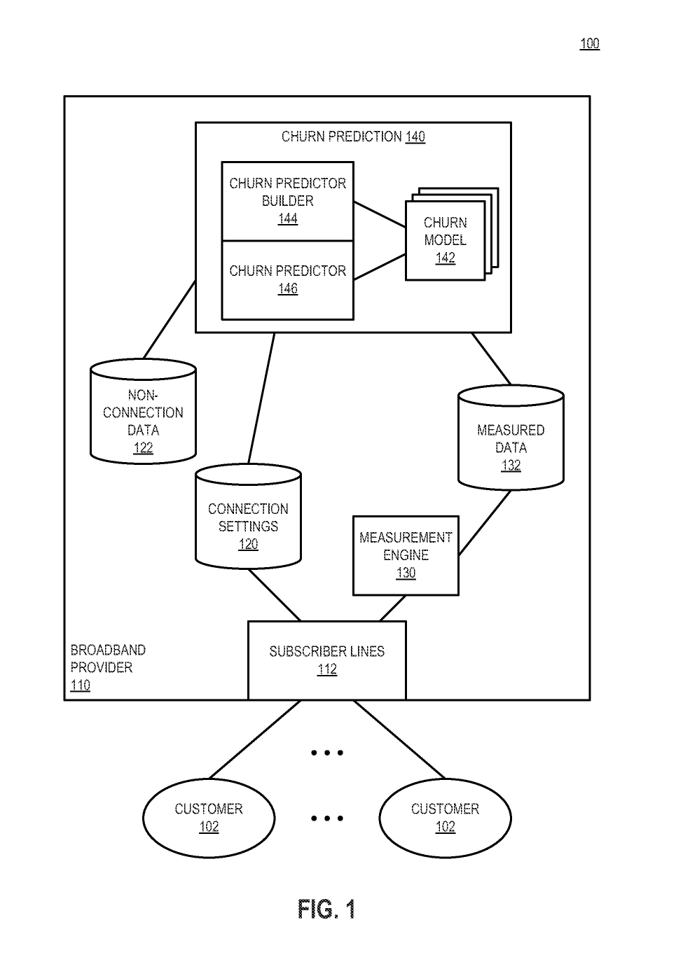

FIG. 1 is a block diagram of an embodiment of a system having a churn predictor that evaluates churn likelihood for customers. System 100 includes multiple customers 102, which are subscribers of subscriber lines 112 of broadband provider 110, and are connected to broadband provider 110 via a network. System 100 can be considered a network of customers and provider. Provider 110 can be a service provider of DSL or cable subscriber lines 112, for example. Each customer 102 has access to a broadband line to a customer premises. It will be understood that a broadband service provider and a broadband connection provider could be the same entity or part of the same corporate entity. However, it is also possible that an entity that provides and maintains the physical lines (i.e., the connection provider) leases and/or licenses another entity to provide broadband service over the lines. Thus, while in many cases the broadband service provider and the broadband connection provider will be the same, they are not necessarily the same. The broadband service provider is motivated to reduce customer churn, and in accordance with what is described herein, can use data obtained from the broadband connection provider. As used herein, broadband provider 110 can refer to either or both provider.

Each subscriber line 112 is operated in accordance with certain configuration parameters, which can be stored in connection settings 120. Each subscriber line 112 has physical configuration data that identifies parameters related to cost, available bandwidth, location, or other information. Connection settings 120 can store information related to a profile of the user or customer 102, such as age, gender, business/home, or other information, as well as connection information. Connection settings 120 can also store other information related to operation of the line such as a monthly data cap, usage history, or other information.

In one embodiment, provider 110 accesses non-connection data 122, which provides data related to the broadband connections of the customers, but not directly about the physical characteristics of any particular broadband connection. Examples of such data can include, but are not limited to competitor offers, weather data, dispatches, or other data. In one embodiment, for purposes of identifying a likelihood of churn, all data not directly related to physical characteristics or physical configuration of a broadband connection could be considered metadata. However, it will be understood that at least some data not directly related to physical characteristics or physical configuration of a broadband connection can be collected generally for the whole network of customers, rather than for a specific customer. Such data can more logically be considered metadata when applied to a specific customer instance generated to assess churn.

Provider 110 can also store measured data 132, as recorded by measurement engine 130. Measurement engine 130 represents any one or more mechanisms that interface with subscriber line 112 to perform monitoring and/or diagnostics of the lines. Measurement engine 130 can measure actual usage of a line, operating bandwidth (which can vary from a rated bandwidth stored in connection settings 120), or diagnostic information such as test results. Information collected by measurement engine 130 is stored as measured data 132. Measured data 132, then, can include data about the performance or operation of the connection of each subscriber line 112, as well as performance of a wireless network router at the customer premises that is connected to the subscriber line 112. Examples of measured data can include physical metrics such as error counts and customer calls. Measurement engine 130 can include mechanisms to communicate with and gather information from a wireless router connected to the subscriber line.

In one embodiment, provider 110 includes churn prediction logic 140, which can in turn include churn predictor builder 144 and churn predictor 146. In one embodiment, at least a portion of churn prediction 140 resides off-site from provider 110, and uses interfaces at provider 110 to collect data and perform services related to churn prediction. For example, churn predictor 146 can reside at an entity that provides monitoring or other services for broadband provider 110. Churn predictor builder 144 generally accesses connection settings 120 and/or measured data 132 and/or non-connection data 122 to generate churn predictor 146. Churn predictor 144 generally accesses connection settings 120 and/or measured data 132 and/or non-connection data 122 to predict customer disconnection, where a customer 102 discontinues broadband service through provider 110. Churn predictor builder 144 and churn predictor 146 do not necessarily reside at the same location. Connection settings data 120 and measure data 132 represent data identifying broadband connection information.

In one embodiment, provider 110 includes a user interface through which customers 102 can monitor their individual subscriber line 112. In one embodiment, the user interface allows a customer to perform monitor or measurement activities related to the customer's subscriber line. Measurement engine 130 can provide the monitoring or measurement data for the customer-initiated measurement data. In one embodiment, measurement engine 130 stores the customer-initiated or user-initiated data in measured data 132, which can then be used by churn prediction 140 in its churn likelihood analysis.

In one embodiment, measurement engine 130 performs measurements in response to a management engine (not specifically shown) that indicates when to collect measurement data, what data to collect, and any other parameters related to data collection. For example, the management engine (or other engine) can cause the provider system to change one or more physical link settings for one or more subscriber line broadband connections to determine how changes to the settings affect performance of the line. Thus, measured data 132 can include data indicating how a subscriber line 112 performed in response to a settings change. Such data can be accounted for in a churn likelihood analysis by churn predictor 146 of churn prediction 140.

Churn prediction 140 obtains or accesses stored data 120 and/or measured data 132 and non-connection data 122 to determine patterns associated with customer churn. Churn prediction 140 can assign multiple variables to account for each configuration settings, measured data parameter, or other performance parameter. Collectively, such data can be referred to as metrics that directly or indirectly reflect customer satisfaction. One common assumption in analyzing churn is that satisfied customers will generally not churn. Thus, metrics related to performance, line configuration, customer service, installation/setup, or other factors can directly or indirectly affect a customer's satisfaction level. Churn prediction 140 can define variables to evaluate the various metrics to identify patterns.

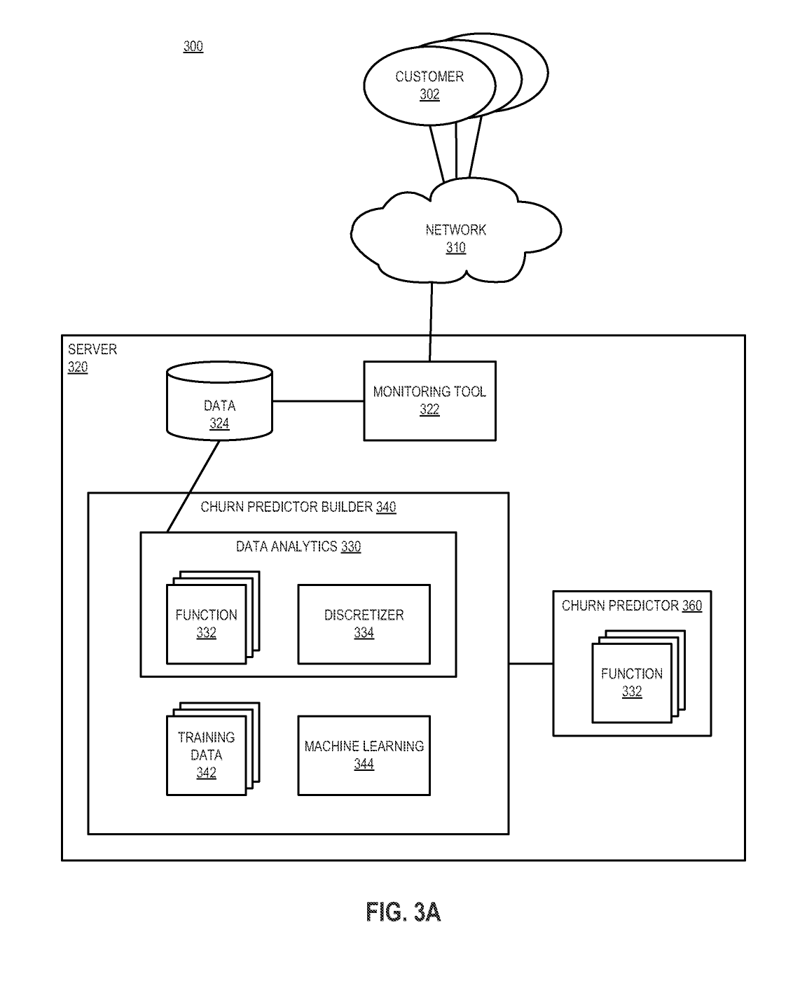

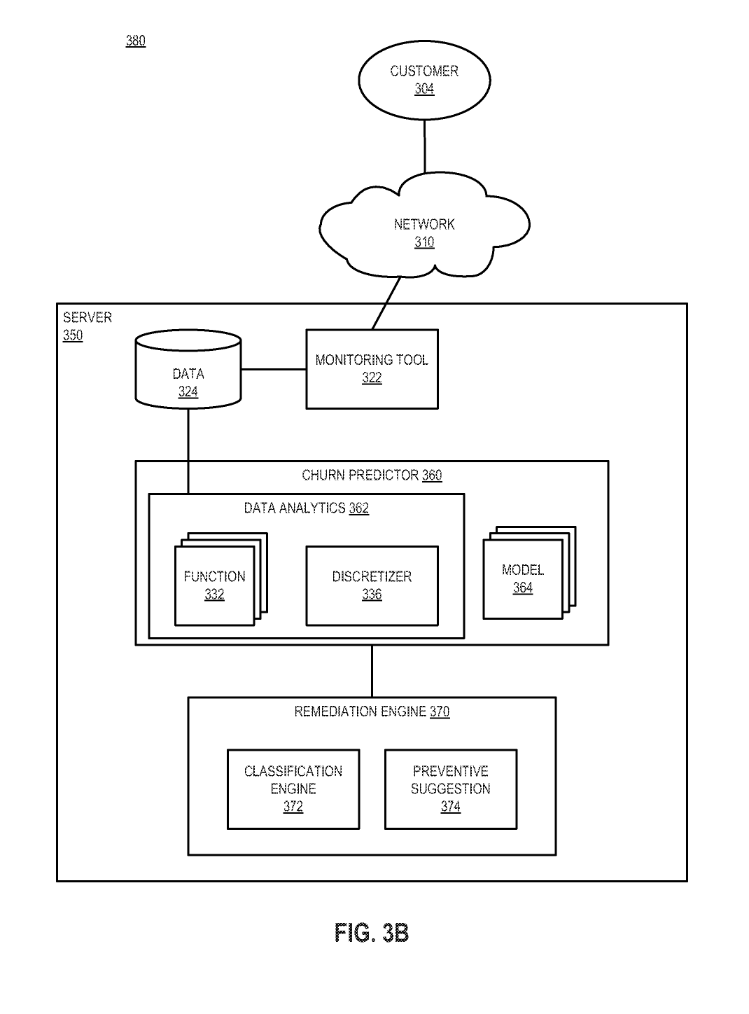

In one embodiment, churn prediction 140 uses one or more churn models 142, which are discussed in more detail below with respect to FIG. 3A and FIG. 3B. Briefly, each churn model 142 is a simple or complex model created from collected data. In one embodiment, churn prediction 140 uses larger number of simpler churn models (referring to the complexity of logic and/or the amount of raw data used to construct the model), and compares customer metrics against each of the multiple models. Churn prediction 140 could alternatively use more complex models based on more raw data per model.

Churn prediction 140 and/or any of its churn models 142 (in an embodiment where multiple models are used) can be constantly updated with new data. With the passage of time, new data is constantly created, which can be relevant to identifying patterns of churners and non-churners. As new data is created, the existing model(s) 142 can be reconstructed using all available data, including the data newly obtained since the model was created. In one embodiment, system 100 keeps existing model(s) 142 for churn prediction 140, and builds new models (not specifically shown) based on all available data, including the data newly obtained. Thus, previous models can be retired instead of updated. In one embodiment, churn prediction 140 keeps existing model(s) 142 and acquires new model(s) from a churn predictor builder that generates the new models based only on the newly obtained data. In such an embodiment, the number of models would obviously increase. Evaluation of a customer can be performed using all available models 142, including newer and older models, with churn predictor 146 generating a churn likelihood score or scores based on all available models. In such an implementation, churn predictor 146 could put more weight on scores from new models, or determine the weight of each model by using a machine learning algorithm such as logistic regression or SVM (support vector machine) to produce the optimal prediction accuracy.

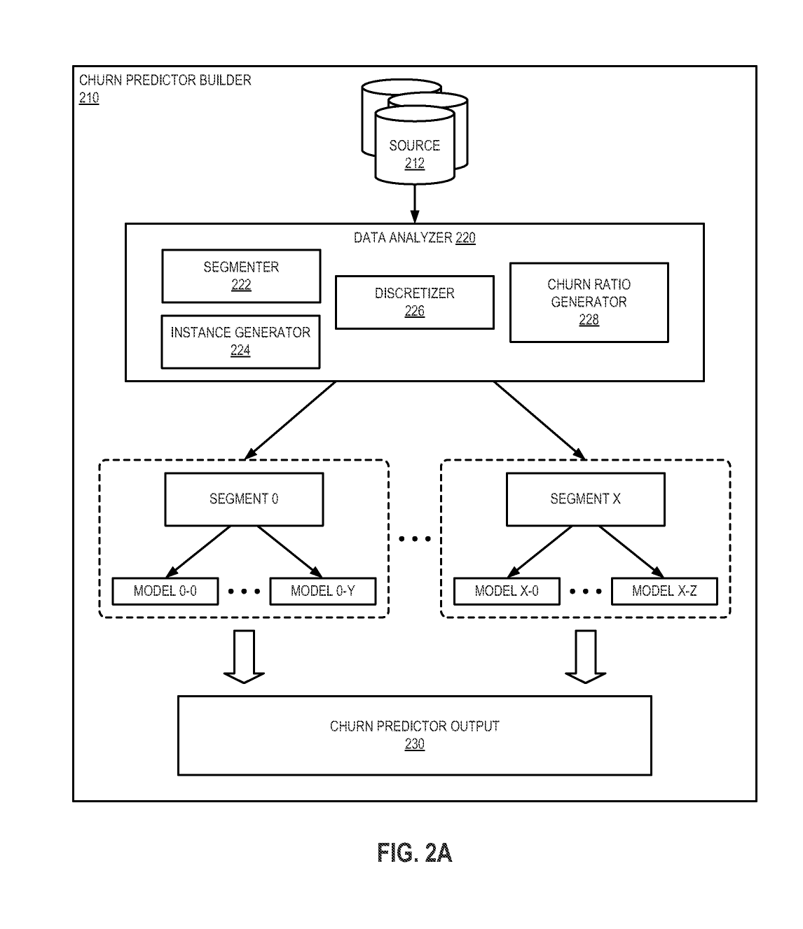

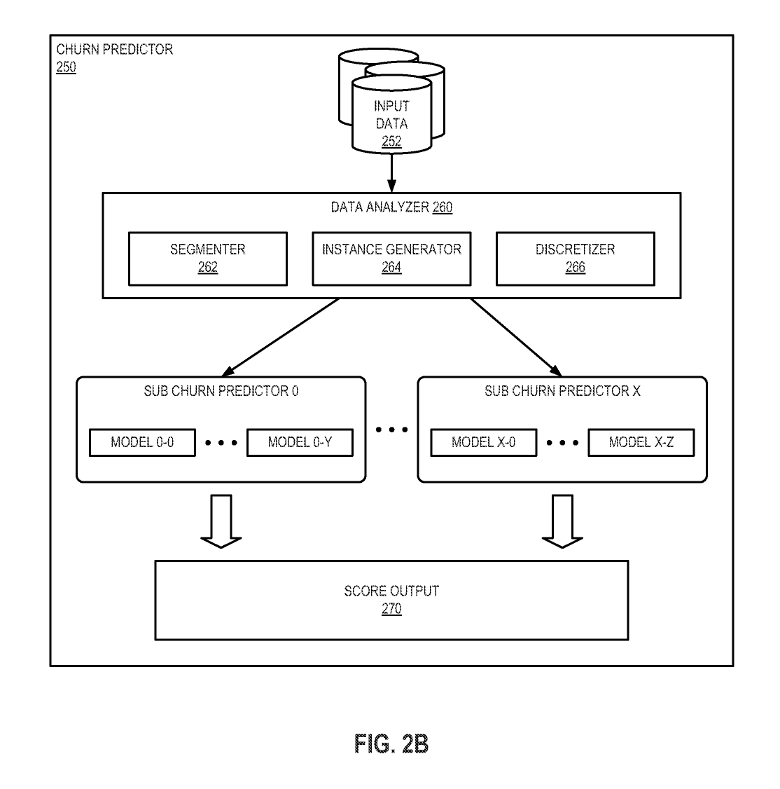

FIG. 2A is a block diagram of an embodiment of a hierarchy of a churn predictor builder. Churn predictor builder 210 obtains data from one or more sources 212. Sources 212 represent both physical line settings or configuration data, customer profile information, measured data, metadata about the configuration data, or any other information or class of data directly or indirectly related to customer satisfaction or customer churn. Builder 210 can obtain the data by storing and maintaining the data in a database, which it then accesses. Builder 210 can access the data from an external data store. In one embodiment, builder 210 is a self-contained module, which receives all data passed to it as arguments from an engine that triggers builder 210 to execute.

Data analyzer 220 represents one or more analysis components of builder 210 to pre-process the raw data received from source(s) 212. Raw data can include operational and performance data for a connection or line, as well as user complaint call data, dispatch (technician visit) data, weather data, competitor offers, customer complaints in public forums, neighborhood data, geographic data, user equipment data (e.g., modem type, modem version, chip vendor) and/or other data. Thus, raw data includes broadband connection data, and can further include metadata or other data used to analyze customer churn. It will be understood that many different pre-processing operations and/or computations can be performed, and they are not necessarily all depicted in FIG. 2A. In one embodiment, analyzer 220 includes segmenter 222, which can segment or separate raw data into logical groups or data sets. The different segments can include geographic groupings, tenure groupings, service level groupings, customer type groupings (e.g., consumer or business), or other type of grouping. Segmentation can organize the raw data into logical sets that can provide useful comparisons during data processing. In one embodiment, analyzer 220 includes instance generator 224, which generates customer instances from the raw data. Each customer instances includes a number of variables, each representing at least one metric related to customer churn.

As a segmentation example, assume that a system includes two segmentation spaces: one for geographical area, and another for tenure. Consider a new customer line in a specific state or province. A customer instance generated to represent the customer line can belong to a geographic segment based on the specific state or province, while also belonging to a tenure segment for new customers. Thus, the same customer instance can have a presence in both segmentation spaces, regardless of whether or not the customer is a churner. It will be understood that a single segmentation space is illustrated.

In one embodiment, instance generator 224 populates a customer instance with default values and/or with maximum high/low values for missing data, extreme data, or other data anomalies (e.g., data outside a statistical range with respect to other customer instances, or outside a valid range that is defined in an applicable technology standard). In one embodiment, analyzer 220 includes discretizer 226, which includes rules or a data model or paradigm for pre-processing input data from source 212. Namely, the input data can include data of many different types, which can be assigned values to provide more accurate use of the data to predict churn. In one embodiment, discretizer 226 enables analyzer 220 to assign null values or other default values for input data with missing or extreme characteristics.

In one embodiment, analyzer 220 includes churn ratio generator 228, which represents logic to determine how to separate the customer instances into training sets. The customer instances are separated into groups with a ratio of churners and non-churners. Typically, the ratio is fairly small (e.g., 4:1 non-churner to churner or less), which has been observed to provide more accurate prediction. In one embodiment, a one-to-one ratio is used. In one embodiment, if the ratio of churners to non-churners is higher than a threshold, churn ratio generator 226 separates data into subsets of data having a ratio of churner to non-churners. Separating the data can improve the accuracy of prediction by keeping the ratio relatively small.

As indicated in the drawing, in one embodiment, builder 210 generates a churn predictor as a collection of sub-churn predictors. The simplest case is a single sub-churn predictor as the churn predictor. In other implementations, each segment generated by segmenter 222 is a separate sub-churn predictor. Assume segmenter 222 separated the raw data into segments 0 through X. Each segment could further be subdivided into one or more models. Segment 0 is shown having model 0-0 through model 0-Y. Each model can be a distinct model result of processing a training data set. In one embodiment, the number of training sets can be different across the different segments. Thus, segment X is shown having model X-0 through model X-Z. It will be understood that X, Y, and Z are integers equal to or greater than 0. In one embodiment, Y equals Z.

The different segments and models within the segments represent hierarchical organization of the raw data into training sets used to process the data. Churn predictor output 230 represents the output of builder 210, which is a churn predictor. It will be understood that the resulting churn predictor will be as hierarchical as the organization of the raw data into training sets used to generate the churn predictor. Thus, builder 210 can generate a churn predictor with a single segment with one or more models, or generate a churn predictor with multiple segments, each having one or more models.

FIG. 2B is a block diagram of an embodiment of a churn predictor hierarchy. Churn predictor 250 is an example of a churn predictor generated by builder 210 of FIG. 2A. Churn predictor 250 has a processing/prediction hierarchy in accordance with the hierarchy of the training data used to generate it. Churn predictor 250 obtains input data 252, which includes data for one or more customers to evaluate for possible churn. Input data 252 can include data from any of data source(s) 212.

Churn predictor 250 includes data analyzer 260. Similar to analyzer 220 of builder 210, analyzer 260 separates data into logical groups for evaluation. Generally, analyzer 260 will organize the data in accordance with the same logic or rules as analyzer 220. In one embodiment, analyzer 260 includes segmenter 262, which can segment or separate raw data into logical groups or data sets. The different segments can include geographic groupings, tenure groupings, service level groupings, customer type groupings (e.g., consumer or business), or other type of grouping. Segmentation can organize the raw data into logical sets that can provide useful comparisons during data processing. Analyzer 260 includes instance generator 264 to generate a customer instance for each customer to be evaluated by churn predictor 250. In one embodiment, analyzer 260 includes discretizer 266, which includes rules or a data model or paradigm for pre-processing input data 252. Namely, input data 252 can include data of many different types, which can be assigned values to provide more accurate use of the data to predict churn. In one embodiment, discretizer 266 enables analyzer 260 to assign null values or other default values for input data with missing or extreme characteristics.

After pre-processing by analyzer 260, churn predictor 250 can evaluate one or more customers by evaluating each customer instance with one or more sub-churn predictors 0 through X (corresponding to segments 0 through X of FIG. 2A). Each sub-churn predictor has one or more models used to evaluate the likelihood of churn for the customer instance. Each sub-churn predictor and each model can generate a churn likelihood score, which is aggregated in score output 270 for a final evaluation or scoring of the customer instance. Score output 270 can combine the scores by summing, averaging, or some other method. Churn predictor 250 can output a single score indicating a prediction, or can output a set of scores, which can then be further evaluated by an engine outside churn predictor, and/or evaluated by an administrator.

FIG. 3A is a block diagram of an embodiment of a system to build a churn predictor. System 300 includes customers 302, which represent a group of customers (which can also be referred to as users or subscribers) that each subscribes to a broadband connection from a broadband provider, such as provider 110 of FIG. 1. Customers 302 connect to the broadband provider over network 310, which represents any type of network, including network interconnection hardware, and which may include publically accessible networks. Server 320 represents a server at the broadband provider. Alternatively, server 320 can connect to the provider over a network, and uses interfaces at the provider.

Server 320 executes on hardware resources, including at least processor(s), memory devices, networking hardware, and interface (human and/or machine interface) hardware. One or more elements of hardware can be shared hardware resources. One or more elements of hardware can be dedicated components, specifically allocated to server 320.

Server 320 performs data collection to access data relevant to customer satisfaction to build a churn predictor. Network monitoring tool 322 collects connection line and/or Wi-Fi (e.g., wireless network) data through network management systems. Such systems are known in the art. The data can include one or more of DSL historical performance counter data, DSL operational data, SELT (single-ended line test) data, throughput data, Wi-Fi performance data, and/or other data. It will be understood that the Wi-Fi performance can be relevant to subscriber line connections because typically the wireless network is not a separate service that customers subscribe to, but rather a communication medium that is connected to a customer's broadband service. Thus, the data collected from Wi-Fi can be used to predict churns of broadband services. The data is stored in data 324, which can be separated into different types of data.

In one embodiment, customers 302 can initiate data collection through a web-based or mobile line test tool, such as a tool that measures upload and download throughputs of broadband connections. Data 324 represents accessed or obtained data used to generate a churn predictor or evaluate a customer with the churn predictor, which data can be stored temporarily (e.g., in volatile memory) or long-term (e.g., as in a database or other nonvolatile storage system). Data 324 can be obtained or accessed from internal source(s) and/or external source(s). Data 324 can include measured data from monitoring tool 322 and/or non-measured data. Non-measured data can include data accessed from a public network (e.g., the Internet). In one embodiment, data 324 includes customer preference data, such as preference on operating requirements (rates, stability, latency, or other requirements). In one embodiment, data 324 can include publically available data that will increase the accuracy of a churn prediction. Such publically available data can include weather data, customer complaints in the open web space, or other publically accessible data.

In one embodiment, data 324 includes customer data related to the subscribed services such as service product requirement, price, service start date, service activation time, customer complaints, service dispatches, or other service data. Data related to the subscribed services can also include customer equipment data. In one embodiment, data 324 includes other data sets such as neighborhood data, geographic data, or other data.

As mentioned above, in one embodiment, an active line optimization engine or component can cause setting changes to a subscriber line and monitor changes to the performance or other data relevant to customer satisfaction. Such active changing of the line settings can be referred to as active data creation from the perspective of data collection. The other aspects of data referred to above that can be collected tend to monitor for any given condition. But to learn more about the subscriber line, or to improve the line's condition, in one embodiment, an automated system (e.g., an automated management engine) can change one or more control line parameters or settings. As a result, additional physical data for the line becomes available. Since the line condition is affected by the changes in control parameters, the customer may notice an improvement or degradation of the subscribed service, and customer calls to the customer support center may occur, or stop occurring. Such customer call data is a part of the raw data that can be collected. Such data can be created by the active data creation process of changing settings. Such data can contribute to provide a richer data set.

Server 320 further performs operations related to data preprocessing. It will be understood that the size of the historical and/or other raw data is humongous, and will frequently contain noisy and/or incorrect values. Data analytics 330 represents tools or components that perform preprocessing on data 324 to derive meaningful metric(s) out of the raw data set and improve the accuracy of the churn predictor. Each preprocessing component or preprocessing operation can be considered to be a function 332. Function 332 can include filtering functions to remove data, as well as derivation functions to derive data from other data. Data analytics 330 uses functions 332 to remove incorrect, invalid, and/or excessive data points.

Data analytics 330 performs the preprocessing of the multiple variables based on rules (e.g., a valuation model or paradigm) for each variable and the accessed data for each customer instance. The value models can be considered to normalize all the different data types to be used together in the machine learning process to provide meaningful training over different types of data input. In one embodiment, data analytics 330 maps from real values to finite number values. Thus, instead of continuous real values, data analytics 330 can map values to one of a set of values. In one embodiment, such a mapping is performed with discretizer 334, described below.

In one embodiment, preprocessing by data analytics 330 includes correcting or removing invalid values collected from network devices based on technology standards applicable to the devices. The correcting and removing can also or alternatively be based on prior knowledge of known bugs, errors, or limitations of specific network equipment or devices. In one embodiment, data analytics 330 computes a distribution for each variable (known as an ‘attribute’ in machine learning). Based on the distribution, data analytics 330 can eliminate the high and/or low Xth percentile of data points (e.g., below 10th and above 90th) from the distribution, which prevents extreme values such as minimum or maximum values from being used. In one embodiment, data analytics 330 can compute basic statistical values such as average, variance, or other computations. Such statistical values can be used in place of raw data, which will operate to reduce the dimensionality of the data. In one embodiment, data analytics 330 computes metrics by using pre-defined functions, which effectively summarizes raw data values, such as stability scores (e.g., an indication of line health, such as a stability score in DSL-Expresse) or steady-state TCP throughput. Again, use of summarizations of the raw data can reduce the dimensionality of the data used to train and/or predict churn. Other functions can be used to derive values by comparison and/or interpolation. It will be understood that reducing the dimensionality can operate to speed up the machine learning and/or churn evaluation operations, and/or require less computational bandwidth to perform the operations.

In one embodiment, data analytics 330 divides the data collection time period into two or more sub-periods. Data analytics 330 can compute the difference between adjacent sub-periods for each variable to capture a trend for each variable (e.g., whether a certain variable goes up or down during the observation period). The observation or collection period represents period between a start date and an end date when historical data is collected, or start and end date of historical data that will be used for consideration (e.g., using only part of the historical data available).

In one embodiment, data analytics 330 generates customer instances from data 324. A customer instance can be understood as a collection of variables or attributes for a specific line. Data analytics 330 can identify customer instances as churners and non-churners based on information in data 324, and label the customer instances with ‘churner’ or ‘non-churner’ designations. In one embodiment, a churner instance can be further classified by type of churner, where each type corresponds to a reason why a customer discontinued service (and thus became a churner).

Some lines may have no data collected for a certain sub-period or for the entire data collection period. In one embodiment, instead of leaving such lines out of the data set, the sub-periods with missing data are marked as ‘no data’ and inserted into the data set. In one embodiment, data analytics 330 includes discretizer 334 to discretize the variables. Discretization can allow a ‘no data’ value to be handled together with other values by the machine learning algorithms. In one embodiment, discretizing the multiple variables includes setting a variable to a preset value when no data is available for a customer instance for a particular sub-period. In one embodiment, the preset value is a NULL value for the variable.

Server 320 performs operations related to building a churn predictor with the collected and preprocessed data. Churn predictor builder 340 represents components and processes through which the raw and/or preprocessed data is processed through machine learning 344 (also referred to as data mining or statistical learning) to build the churn predictor. The machine learning process can be referred to as training the model or models. The preprocessed data to be used to build the churn predictor includes the data for many customers, including both churners and non-churners. Such data received at builder 340 can be referred to as training data 342. There are many possible machine learning tools, one or more of which builder 340 uses to build the churn predictor. The machine learning component(s) are represented as machine learning 344. Machine learning 344 can include custom (proprietary) and/or open-source (e.g., WEKA) machine learning tools to train a churn predictor. In one embodiment where discretization is used, algorithms such as Bayes network can be used to handle discretized values for a data set including null values.

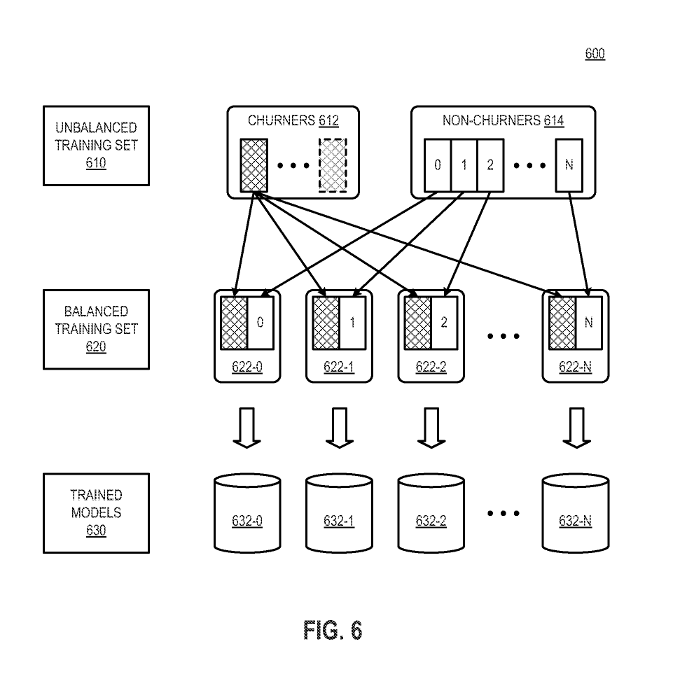

In one embodiment, builder 340 divides training data 342 into multiple subsets. Typically the number of churners is much smaller than the number of non-churners in the data set. In one embodiment, a ratio of churner and non-churners is used in each subset to avoid biasing the training. In one embodiment, the ratio is 1:1 (i.e., an equal number of churners and non-churners), but ratios of 1:2 or other ratios can be used. Typically the ratio of churners to non-churners is much, much less than the ratios that would be used to perform training. Due to the smaller number of churners, the same churners instances can be repeated over multiple or all data sets, whereas non-churner instances may appear only once in one of the multiple subsets (see the description of FIG. 6 below for more details). In one embodiment, builder 340 generates N models from the N subsets.

In one embodiment, training data 342 represents customer lines grouped in accordance with tenure, where tenure is one example of a type of segmentation. Such an approach can improve prediction accuracy in some implementations. Additionally, or alternatively, geographic data associated with each customer instance can be used to segment training data 342. As one example of possible groupings, tenure groups of 0 to 2 weeks, 2 to 4 weeks, 4 to 13 weeks, and 13+ weeks has been found to be effective. When such tenure groupings are used, the input data sets are divided into a number of smaller disjointed sets according to tenure of individual lines. Then, separate churn predictors can be built per tenure group. Builder 340 generates an output of a trained system, which is stored as the churn predictor. As described above, the churn predictor can have multiple different churn models based on different subsets of data.

Churn predictor builder 340 generates or outputs churn predictor 360, described below with respect to FIG. 3B. Churn predictor 360 includes one or more models 364 to use to perform churn prediction.

FIG. 3B is a block diagram of an embodiment of a system to generate a churn prediction. System 380 includes customer 304, which represents a customer (or sub-group of customers) that subscribes to a broadband connection from a broadband provider, such as provider 110 of FIG. 1. Where a churn predictor builder uses training to automatically or semi-automatically discover patterns, a churn predictor uses testing or evaluation to detect a customer instance that exposes a signature that is statistically similar to a churner's pattern. Specifically, customer 304 is selected to be evaluated for possible churn. A system can perform routine or regular monitoring and data mining to evaluate for possible churners. For example, data can be collected and analyzed daily or multiple times per day, or some other frequency. Customer 304 can be one of customers 302 of FIG. 3A, which connects to the broadband provider over network 310. Server 350 represents a server at the broadband provider. Alternatively, server 350 can connect to the provider over a network, and uses interfaces at the provider.

Server 350 executes on hardware resources, including at least processor(s), memory devices, networking hardware, and interface (human and/or machine interface) hardware. One or more elements of hardware can be shared hardware resources. One or more elements of hardware can be dedicated components, specifically allocated to server 350. Server 350 performs operations specifically directed to predicting whether a particular customer 304 is likely to churn, or whether a sub-group of customers 304 includes any potential churners. In one embodiment, server 350 is the same server as server 320 of FIG. 3A. In one embodiment, server 350 is a separate server from server 320. In one embodiment, servers 320 and 350 are not located at the same premises. In one embodiment, servers 320 and 350 are run and managed by different business entities.

Server 350 performs data collection to access data relevant to customer data 352, which can be data obtained from data 324 of FIG. 3A. Customer data 352 includes data related to at least the many of the same variables as used by server 320 to generate the churn predictor. Thus, customer data 352 is compatible with one or more prediction models of churn predictor 360, which is an example of the churn predictor generated by builder 340 of FIG. 3A.

Server 350 performs operations to predict churn likelihood for customer 304. To predict the churn likelihood of a line, the same set of variables should be prepared as set out in FIG. 3A for building the churn predictor. Thus, server 350 includes a preprocessing component, which is not explicitly shown. As in FIG. 3A, a preprocessor will generate a customer instance to represent the line to be tested. It will be understood that when evaluating a customer line for churn likelihood, a field or label of churner/non-churner does not apply to the customer instance. The data preprocessing creates the customer instance with multiple variables, each representing a parameter related to the broadband connection. Churn predictor 360 runs the customer instance through the models of the churn predictor (e.g., such as the N models built in the training as discussed above). The churn prediction, via the models, effectively compares the customer instance for customer 304 against training data, which represents the measured data and configuration data for other customers including churners and non-churners.

Server 350 further performs operations related to data preprocessing. More particularly, churn predictor 360 includes data analytics 362, which represents one embodiment of a data analytics mechanism such as data analytics 330 of FIG. 3A. In one embodiment, data analytics 362 is the same as data analytics 330. In one embodiment, there are some changes between the two data analytics mechanisms related to the differences in generating a churn predictor versus performing churn prediction. Generally, data analytics 362 represents tools or components that perform preprocessing on data 324 to derive meaningful metric(s) out of the raw data set and improve the accuracy of the churn prediction. Each preprocessing component or preprocessing operation can be considered to be a function 332. Function 332 can include filtering functions to remove data, as well as derivation functions to derive data from other data. Data analytics 362 uses functions 332 to remove incorrect, invalid, and/or excessive data points. Data analytics 362 can include the same set of functions 332 as data analytics 330, but could alternatively be different. In one embodiment, data analytics 362 includes discretizer 326, which can be the same as, or a variation of, discretizer 324 of FIG. 3A. Discretizer 326 generally provides the same functions as discretizer 326 in the context of applying churn prediction models.

In one embodiment, each model of churn predictor 360 produces a confidence score for a given input customer instance being evaluated. The confidence score can be provided within a range, from a lowest score or rating to a highest score or rating, such as a decimal value from 0 to 1, a value from 1 to 10, an integer value from 1 to 100, or some other range. The upper and lower bounds of the range can be set in accordance with the design of the churn predictor models. The churn likelihood for the customer instance is generated based on a combination or composite of the confidence scores produced by the models. In one embodiment, churn predictor 360 combines confidence scores by either generating an average of the confidence scores (average confidence), or by generating a confidence vote. In one embodiment, churn predictor 360 performs voting by having a preset threshold (a value within the range), and for confidence scores higher than the threshold, it is marked as 1 or TRUE or CHURNER, and otherwise a 0, FALSE, or NON-CHURNER. Thus, the output of each churn predictor model is interpreted as a binary output, which indicates whether a line is classified as a churner or not for that particular model. Churn predictor 360 can then generate an output indicating how many of the models predict the customer line will be a churner. It will be understood that where customer 304 represents a group of customers, each line would typically be evaluated separately based on its own customer instance.

In one embodiment server 350 performs remediation via remediation engine 370 for lines predicted as churners. After churn predictor 360 generates a churn likelihood score for the customer line or lines being evaluated, remediation engine 370 suggests preventive actions with preventive suggestion 374. In one embodiment, remediation engine 370 classifies a predicted churner with classification engine 372 based on a classification system. In one embodiment, such a classification system is built by churn predictor builder 340 of FIG. 3A, because the classification system requires training to identify classes. In one embodiment, another mechanism is used to build the classification system for purposes of remediation.

It will be understood that for most practical implementations, a group of customers 304 will be evaluated, typically one at a time, to assign a churn likelihood score for each customer line. Once each line is assigned a churn likelihood score, the lines can be sorted by remediation engine 370 according to a predefined ordering (e.g., descending order, or ascending order if the upper and lower bounds are swapped). A broadband service provider operator will typically have a fixed budget to spend for preventive actions. Thus, server 350 can indicate the top M lines (or the top P % of lines) with scores indicating the highest likelihood of churn, which can then be chosen for preventive action. Churn predictor 360 predicts the churn likelihood of the lines, but may not explicitly provide a reason. Remediation engine 370 can make a recommendation on preventive action for predicted churns.

In one embodiment, classification engine 372 uses one of the following classification systems to classify predicted churners: multi-class classification, classification via clustering, or via an expert system. Multi-class classification can provide churn groups, such as NEVER_USED (e.g., the customer did not use the service or was not serious about the service), POOR_SUPPORT (SERVICE) (e.g., the customer was not satisfied with the provider's technical/call support), POOR_QUALITY (PERFORMANCE) (e.g., the customer was dissatisfied with the quality of the subscriber line), POOR_VALUE/PRICE (PRICE) (e.g., the customer did not find the value adequate for the price or not as competitive as alternative options), and/or other groups. Such groups can be derived, for example, from tracking information in a CRM (customer relationship management) database, which keeps the end date of the service of a customer and the churn reason (if provided). Even if the reason given by the customer is not completely reliable, it can still provide useful information.

Based on the above example classification types, preventive suggestion 374 can suggest actions such as the following, which is meant only as a non-limiting example. For a line classified as NEVER_USED, a suggested action can be to contact the customer to determine if there is any issue with installation or the need for education for the service. For a line classified as PERFORMANCE, a suggested action can be to send a technician to fix a physical problem associated with the line or customer premise equipment (CPE). Alternatively, a suggested action can be to run an automated line optimization process (e.g., a Profile Optimization) to modify one or more control parameters associated with the line's operation. For a line classified as PRICE, a suggested action can be to offer a credit or discount, or offer a temporary free service upgrade. For a line classified as POOR SERVICE, a suggested action can be to offer a credit or discount, send an apology letter, or other action.

Classification via clustering can be used when no churn reason or churn type information is available. Classification via clustering can be executed as a meta classifier (e.g., based on a machine learning algorithm) that uses a clusterer for classification. The algorithm can operate by clustering instances based on a number of cluster classes provided by the user (e.g., the operator of the system providing churn prediction). The machine learning algorithm performs an evaluation routine to find a minimum error mapping of clusters to classes. The clusters are groups of customer instances with similar profiles.

An expert system can be based on expert analysis of the individual line's attributes. In one example, the system operator can run a dispatch engine on the predicted churns as indicated by the churn predictor. For lines that do not get dispatch recommendations, the system operator can check attributes such as rates, stability, and loop lengths. The system operator then applies domain knowledge to recommend actions such as: service downgrade or service upgrade, port reset, PO trigger (e.g., if lines have not been under PO yet), offer monetary credits (e.g., a discount).

Alternatively to using preventive suggestion 374, a system operator can simply contact customers indicated as predicted churns. The system operator could also provide automatic configuration changes to improve connection performance of a predicted churn.

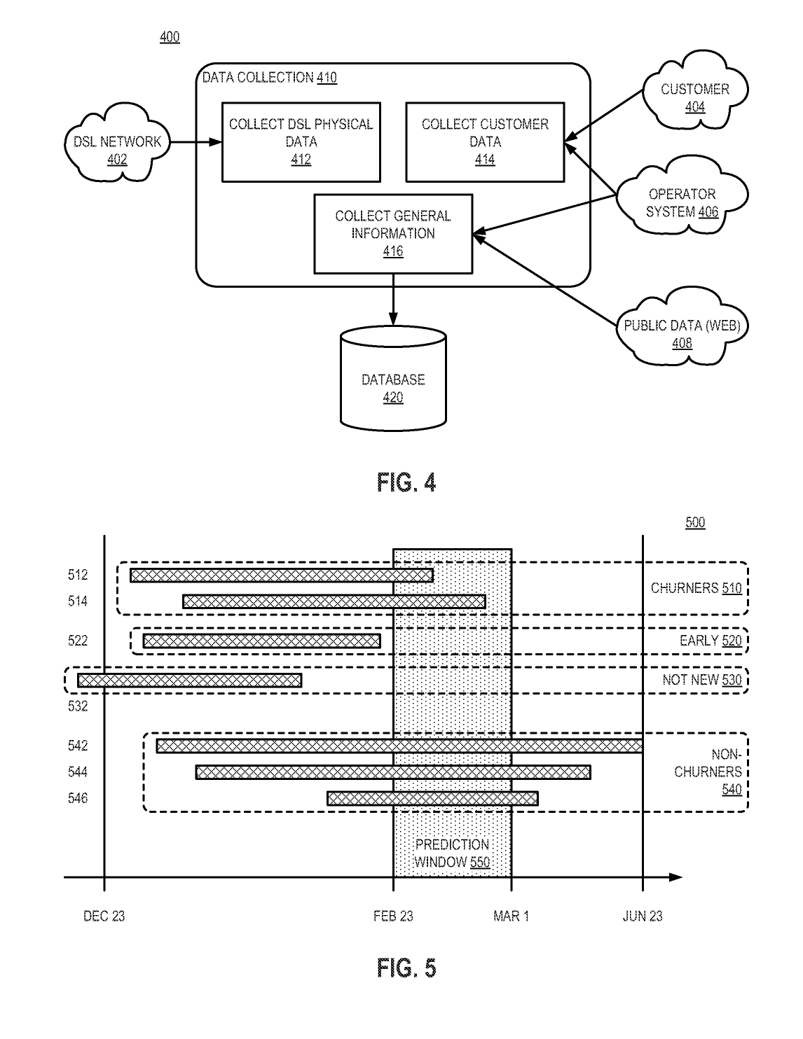

FIG. 4 is a block diagram of an embodiment of a data collection system used in churn prediction. System 400 includes data collection 410 and various examples of data sources 402, 404, 406, and 408. System 400 also includes database 420 to store the collected data. In one embodiment, database 420 is data 324 of systems 300 and 380 discussed above. Data collection 410 can include collecting physical data about the configuration of the connection (e.g., DSL physical data), and other data, such as customer information, previous churner data, and general information. In one embodiment, data collection 410 is initiated by a network operator. In one embodiment, data collection 410 is initiated, at least with respect to one line, by a customer.

Physical data is represented with collect DSL physical data 412. Data 412 is collected from the DSL network itself or other broadband network, including the connections and settings at the line and/or service provider. Customer information and data regarding churners is represented with collect customer data 414. Data 414 is collected from customer information 404, and from operator system 406. Operator system 406 represents the broadband service provider, which has information about the customer. Data 414 can include churner data, which can include information about why a customer churned (churn reason), and/or what competitors were doing at the time of churn. If no churn reason is available, system 400 can cluster the churners to compute common characteristics of the group. General information is represented with collect general information 416. Data 416 is collected from operator system 406 and public data 408. General information can include weather/natural disaster information, economic information, competing services, technology change information, or other information.

With current technology, it is impractical for a broadband provider to use a network management system to monitor the networks in a continuous way. A broadband provider may have thousands or millions of lines, which would result in very large amounts of data. Frequent data collection could be a significant burden to network elements and consume network bandwidth, which could in turn interrupt other important requests like provisioning of lines or changing configurations. In one embodiment, data collection 410 operates to collect network data once or twice per day for the entire network. In one embodiment, a line considered at risk (by evaluation with a churn predictor) can be monitored more frequently. In one embodiment, data collection 410 performs more frequent data collection for recently activated lines, or for the customers who recently complained of the service quality.

It will be understood that data collection in a broadband network is different than in cellular or other wireless networks where a customer's usage pattern is easy to determine. Broadband lines such as DSL or cable are often always online, which makes it more difficult to determine the customer's usage pattern. Some network devices provide customer traffic pattern, but such information is typically limited, and often not available for analysis. In one embodiment, data collection 410 uses active probing, which allows system 400 to detect if a connection line is in sync. If the line is in sync, data collection 410 can measures its performance parameters.

FIG. 5 is a block diagram of an embodiment of applying churn prediction to customers within a prediction window for training a churn predictor. Graph 500 provides a graphical representation of different churn prediction scenarios. As shown, a broadband provider performs churn prediction for prediction window 550, which has a period of time of interest. As shown, the period of time of interest is one week (February 23-March 1), but the period of time of interest could be more or less. Graph 500 includes a start reference date of December 23 and an end reference date of March 1, which is the period of time for which data collection (such as shown in FIG. 4) will be performed. In graph 500, it is assumed that the current date is on or after the shown extended period of time of June 23. It will be understood that the specific dates mentioned are merely for purposes of illustration, and are not limiting on the start reference, end reference, prediction window, or the number of days in any given period. Training typically includes generating prediction training for various different prediction windows 550. In one embodiment, the data collection period occurs entirely before prediction window 550, such as a data collection window of 90 days prior to a prediction window of 14 days. Other time periods can be used for the data collection window (e.g., longer or shorter than 90 days) as well as for the prediction window (e.g., longer or shorter than 14 days). In one embodiment, prediction window 550 is a sliding window with fixed collection and prediction periods, where an end reference date can be based on the current date.

Customers are represented by the bars across the graph, and are designated as 512, 514, 522, 532, and 542. For purposes of graph 500, assume that only new customers are of interest, or customers that activated service since start reference date 502. Under such an assumption, customer 532 may not be used in training the churn predictor because the customer is not new 530. Other categories of customers can include churners 510, early 520, and non-churners 540. Customers 512 and 514 are identified as churners, because they are likely to churn within prediction window 550. Customer 522 is early because the customer churned prior to prediction window 550.

Just as churners 510 can be used to train churn prediction for prediction window 550, non-churners 540 are also used to train churn prediction for prediction window 550. In one embodiment, non-churners 544 and 546 are used as churners to train churn prediction for prediction window 550 because they do not churn within prediction window 550, even though they churn later. Thus, customers 544 and 546 are late churners because the customers will churn after the prediction window, and thus can be used as churners for churn prediction training for a later prediction window. In one embodiment, because non-churners 544 and 546 churn shortly after prediction window 550, they are used as churners to train churn prediction for prediction window 550. Customer 542 is a complete non-churner, because the customer does not churn at all through the last date. In one embodiment, late churners are not considered as churners in training churn prediction. However, it will be observed that customer 546 churns just a little after prediction window 550, and so may actually have more in common with churners 510 than with non-churner 542. The further from prediction window 550 a customer churns, such as customer 544, the less likely it is that their behavior can be considered the same as those customers (e.g., 512 and 514) that churn during the prediction window. Again, the sliding window of churn prediction training can address customers 544 and 546 as churners for a later window.

It will be understood that prediction window 550 is one example of a period of interest or a target period, which could be made smaller or larger, depending on the implementation. Additionally, the period between a start reference date and end reference date can also be made larger or smaller. The data collection period can further be subdivided into multiple sub-periods. The churn predictor could then identify a trend for each of the multiple variables for each customer based on computing a different between adjacent sub-periods. Thus, for example, the churn of customer 512 and 514 can be predicted based on how they compare to previous churners, and/or based on how their measured data indicates a trend to a comparison to previous churners.

In one embodiment, data can be divided into sub-periods of equal length, or sub-periods of unequal length that are based on events of interest. In one embodiment, the start reference date can be based on an event, and other sub-periods of time can be based on subsequent events. An event can include a dispatch, an abrupt change in system data, or other event. Sub-periods permit information about trends of customers. A trouble ticket or service ticket can indicate an abrupt change in customer data and experience, which can be used as the basis to evaluate a line for churn. In one embodiment, events are not considered in the evaluation until a period of time (e.g., one or two days) has passed after the event.

FIG. 6 is a block diagram of an embodiment of a system to generate churn prediction models based on churner and non-churner subset information. System 600 represents a churn predictor builder, in accordance with any embodiment described herein. System 600 illustrates one embodiment of applying a ratio of churners and non-churners to generate separate churn predictor models. Unbalanced training set 610 includes customer instances for churners 612 and non-churners 614. Churner group 612 can include one or multiple churners. Non-churner group 614 includes multiple non-churners. A ratio of churners to non-churners is selected for each group in balanced training set 620. As illustrated, the ratio is 1:1, but other ratios will be understood from the simplified example shown.

In one embodiment, system 600 applies a single churner instance to each balanced set 620 (sets 622-0 through 622-N). In an alternative embodiment, a single group of multiple churners could be applied to each balanced set 620. One or more non-churners 614 are also applied to each balanced set 620. In one embodiment, a churner may be applied to multiple balanced sets 620, but a churner is applied to only a single balanced set 620. In one embodiment, multiple non-churners 614 are applied to each balanced set 620. In one embodiment, building the balanced sets 620 includes mapping real values to a finite set of value, or other form of discretization. Such a mapping can act as a noise filter to reduce the occurrence of spurious values in the training sets, which is performed in preprocessing. In one embodiment, customer instances include a bin ID, which refers to a grouping of the variables. The bin ID can serve as an example of a discretized metric or variable, and in one embodiment, each variable has a unique discretization bin ID. For example, a bin array can include a number of weeks that a line has been in the broadband network (how long since the customer activated service), and based on the number of weeks, the customer is considered part of one of the bins in the array (e.g., bin 0 as 0 to 1 week; bin 1 as 2 to 4 weeks; bin 2 as 5 to 7 weeks; or bin 3 as 8+ weeks). Thus, the bin ID number can represent a usable finite metric to use in place of a random metric (e.g., use ‘0’ instead of ‘10 days’).

System 600 performs machine learning on balanced sets 620, which is the input data. The machine learning computations discover patterns common to churners, and result in trained models 630. There is a trained model 632-0 through 632-N generated by using machine learning for each balanced set 622-0 through 622-N used to perform the machine learning. The models can then be used for testing or evaluation of customers, which refers to taking input data and determining how likely it is that a customer will churn. The likelihood is based on how close the evaluated customer is to the pattern(s) of past churners. In one embodiment, the system and/or operators of the system can select a portion of lines likely to churn, and suggest actions to try to prevent churn.

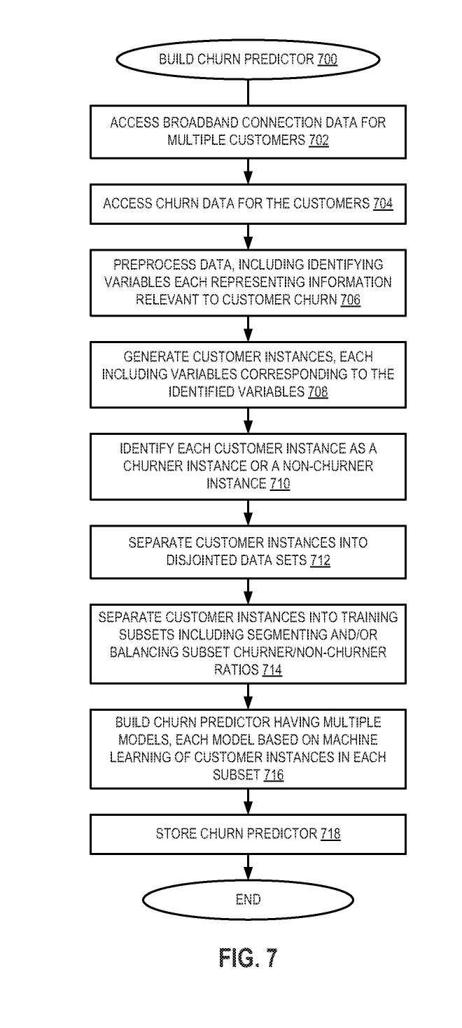

FIG. 7 is a flow diagram of an embodiment of a process for building a churn predictor in accordance with generation process 700. A server device includes a churn predictor builder, which accesses broadband connection data for multiple broadband customers, 702. In one embodiment, the churn predictor builder also accesses other data related to customer satisfaction, but not directly about the broadband connection. The churn predictor builder can identify distinct customers (e.g., identified as distinct lines) and also accesses churn data for the customers, 704, allowing the churn predictor builder to identify each customer as a churner or non-churner.

In one embodiment, the churn predictor builder preprocesses the accessed data, including identifying variables each representing information relevant to customer churn, 706. The multiple variables can directly or indirectly represent information about customer churn, being associated with connection information or with data not directly about the connection. The preprocessing includes assigning the variables value based on rules for each variable, or deriving other metrics as a new variable. The churn predictor builder generates customer instances, which each include variable corresponding to the variable identified in the preprocessing, 708. Based on the churner data obtained, the churn predictor builder can specifically label a customer instance as a churner or non-churner, 710.

In one embodiment, the churn predictor builder separates the customer instances into disjointed data sets, 712. In one embodiment, there is only one data set. The disjointed data sets can each represent a different logical grouping of the customer instances based on information identified in the preprocessing of the raw data. In one embodiment, the churn predictor builder separates the customer instances into multiple training subsets, 714. Separating into training sets can include separating customer instances into segments (e.g., refer to FIGS. 2A and 2B) and/or balancing a ratio of churners and non-churners in a set (e.g., refer to FIG. 6). In one embodiment, there is only a single training set. The churn predictor builder builds a churn predictor based on the training data. In one embodiment, the churn predictor builder builds a churn predictor with multiple models, each model based on machine of the customer instances in each subset, 716. If there is only one training set, the churn predictor builder can generate a churn predictor or sub-churn predictor with a single model. The churn predictor builder stores the generated model as a churn predictor to use to evaluate other customers, 718.

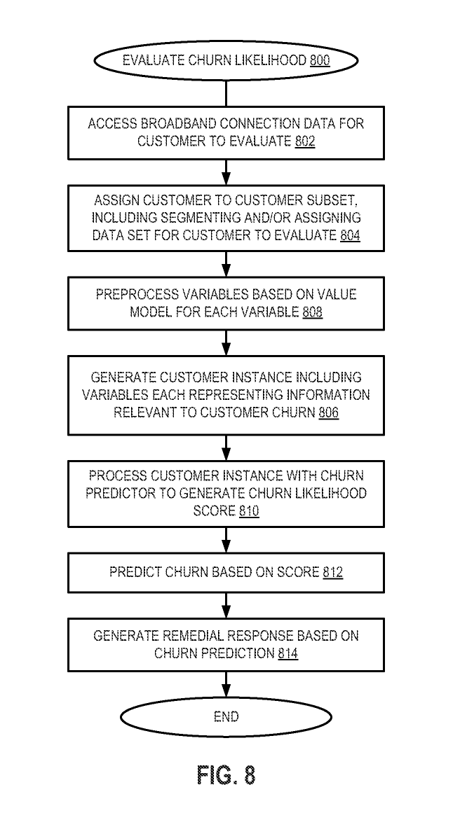

FIG. 8 is a flow diagram of an embodiment of a process for predicting customer churn with a churn predictor in accordance with evaluation process 800. A churn predictor can be built in accordance with what is described above with respect to process 700. The churn predictor accesses broadband connection data for a customer to be evaluated, 802. In one embodiment, the churn predictor also accesses other data relevant to customer satisfaction or to customer churn to use in the evaluation. The other data does not necessarily describe or represent physical connection data for the customer line.

In one embodiment, the churn predictor uses segmentation to evaluate a customer line. In one embodiment, each customer instance is evaluated in accordance with each segment or sub-churn predictor. In one embodiment, the churn predictor can assign the customer instance to a subset, 804, which can include a segment or other data set to which the customer instance is assigned for evaluating the customer. The churn predictor preprocesses the variables based on rules for each variable to assign values to the variables based on the input data, 806. The churn predictor generates a customer instance to represent the customer line, and produces multiple variables each representing information relevant to customer churn, 808. In one embodiment, the multiple variables for the customer instance are created in accordance with the data training model used to generate the churn predictor.

The churn predictor processes the customer instance with one or more churn predictor segments and/or one or more churn predictor models to generate a churn likelihood score(s), 810. In one embodiment, the churn predictor passes the scores to a network operator for evaluation. In one embodiment, the churn predictor generates a final churn prediction based on the score(s), 812, such as by combining scores of different segments/models. In one embodiment, the churn predictor generates a remedial response based on the churn prediction, 814. At least part of the remedial response can be performed automatically by the churn predictor. The remedial response options can include a variety of automated and non-automated actions to try to prevent customer churn for a customer identified as likely to churn.

Flow diagrams as illustrated herein provide examples of sequences of various process actions. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

It is therefore in accordance with the above teachings there is according to one embodiment, a system for computing a likelihood that a broadband connection service will be terminated, including: a physical connection monitoring subsystem including a storage device to store broadband connection information, the physical connection monitoring subsystem to access data identifying the broadband connection information, including data identifying physical layer broadband connection information, and churn indication, for multiple different subscriber lines of a broadband connection provider; a data processing subsystem executed on a server device to identify in the accessed data multiple variables each representing information relevant to the churn indication and assign values to the multiple variables based on valuation rules for each variable; and a model building subsystem including a machine learning network executed on a server device to: generate subscriber line instances, each subscriber line instance associated with a subscriber line identified in the accessed data, each subscriber line instance including the assigned values for the multiple variables and indicating whether the broadband connection service for the subscriber line is likely to be terminated; and build a churn predictor based on machine learning processing of the subscriber line instances.

According to another embodiment of the system, the physical connection monitoring subsystem is to access broadband connection metadata identifying the broadband connection information.

According to another embodiment of the system, the multiple variables include metrics that directly or indirectly reflect customer satisfaction with the broadband service connection for the subscriber line.

According to another embodiment of the system, the physical connection monitoring subsystem is to access measured data about the broadband connection.

According to another embodiment of the system, the measured data includes one or more of connection operational data, connection performance data, or performance of a wireless network connected to the connection.

According to another embodiment of the system, the physical connection monitoring subsystem is to access measurement data initiated by a user of the subscriber line.

According to another embodiment of the system, the physical connection monitoring subsystem is to access the data identifying the broadband connection information as measurement data created in response to changing one or more physical link settings for the broadband connection to determine a change to performance.

According to another embodiment of the system, the physical connection monitoring subsystem is to access operational and performance data for broadband connections of the broadband connection provider, as well as accessing one or more of complaint call data, dispatch data, weather data, competitor offers, customer complaints in public forums, neighborhood data, geographic data, and/or user equipment data.

According to another embodiment of the system, the physical connection monitoring subsystem accessing the data identifying the broadband connection information further includes the physical connection monitoring subsystem to divide measurement data for a collection period into multiple sub-periods; and compute a difference between adjacent sub-periods to determine a trend for each of the multiple variables.

According to another embodiment of the system, the model building subsystem is to generate the subscriber line instances including setting a variable value to an upper or lower limit for subscriber line instances having data with an invalid or extreme value.

According to another embodiment of the system, the model building subsystem is to generate the subscriber line instances including classifying churners where the broadband connection service was terminated by type of churner, where each type corresponds to a reason why the broadband connection service was terminated.

According to another embodiment of the system, the model builder subsystem is to further segment the subscriber line instances based on geographic data or tenure of the subscriber line, in which building the churn predictor includes the model builder subsystem to build different churn predictors for each geographic segment or for each tenure segment, and generate the subscriber line instances based on the segmenting.

According to another embodiment of the system, the data processing subsystem is to discretize the multiple variables in accordance with the valuation rules for each variable.

According to another embodiment of the system, discretizing the multiple variables further includes setting a preset value for any variables for which no data is available for a subscriber line instance.

According to another embodiment of the system, setting the preset value includes setting a null value for the variable.

According to another embodiment of the system, the data processing subsystem is to compute one or more of the multiple variables as a value derived from accessed data.

According to another embodiment of the system, the model builder subsystem is to further separate the subscriber line instances into subsets, each subset including churners and non-churners; and in which building the churn predictor further includes the builder subsystem to build a churn predictor having multiple different churn prediction models, each model based on machine learning processing of the subscriber line instances in each separate subset.

According to another embodiment of the system, the model builder subsystem is to separate the subscriber line instances into subsets including placing a ratio of churners and non-churners in each subset.

According to another embodiment of the system, the model builder subsystem is to separate the subscriber line instances into subsets including placing a balanced number of churners and non-churners in each subset.

According to another embodiment of the system, the model builder subsystem is to separate the subscriber line instances into subsets including assigning all churners to every subset, and assigning each non-churner to only one subset.

In accordance with one embodiment there is a method for computing a likelihood that a broadband connection service will be terminated, including: accessing data identifying broadband connection information including data identifying physical layer broadband connection information, and churn indication, for multiple different subscriber lines of a broadband connection provider; identifying in the accessed data multiple variables each representing information relevant to churn and assigning values to the multiple variables based on valuation rules for each variable; and generating subscriber line instances, each subscriber line instance associated with a subscriber line identified in the accessed data, each subscriber line instance including the assigned values for the multiple variables and indicating whether the broadband connection service for the subscriber line is likely to be terminated; building a churn predictor based on machine learning processing of the subscriber line instances.

According to another embodiment of the method, accessing the data identifying the broadband connection information includes accessing broadband connection metadata.

According to another embodiment of the method, the multiple variables include metrics that directly or indirectly reflect customer satisfaction with the broadband service connection for the subscriber line.

According to another embodiment of the method, accessing the data identifying the broadband connection information includes measured data about the broadband connection.

According to another embodiment of the method, the measured data includes one or more of connection operational data, connection performance data, or performance of a wireless network connected to the connection.

According to another embodiment of the method, accessing the data identifying the broadband connection information includes accessing measurement data initiated by a user of the subscriber line.

According to another embodiment of the method, accessing the data identifying the broadband connection information further includes accessing measurement data created in response to changing one or more physical link settings for the broadband connection to determine a change to performance.

According to another embodiment of the method, accessing the data includes accessing operational and performance data for broadband connections of the broadband connection provider, as well as accessing one or more of complaint call data, dispatch data, weather data, competitor offers, customer complaints in public forums, neighborhood data, geographic data, and/or user equipment data.

According to another embodiment of the method, accessing the data identifying the broadband connection information further includes dividing measurement data for a collection period into multiple sub-periods; and computing a difference between adjacent sub-periods to determine a trend for each of the multiple variables.

According to another embodiment of the method, generating the subscriber line instances includes setting a variable value to an upper or lower limit for subscriber line instances having data with an invalid or extreme value.

According to another embodiment of the method, generating the subscriber line instances further includes classifying churners where broadband connection service was terminated by type of churner, where each type corresponds to a reason why broadband connection service was terminated.

According to another embodiment, the method further includes: segmenting the subscriber line instances based on geographic data or tenure of the subscriber line, in which building the churn predictor includes building different churn predictors for each geographic segment or for each tenure segment, and generating the subscriber line instances based on the segmenting.

According to another embodiment of the method, identifying the multiple variables includes discretizing the multiple variables in accordance with the valuation rules for each variable.

According to another embodiment of the method, discretizing the multiple variables further includes setting a preset value for any variables for which no data is available for a subscriber line instance.

According to another embodiment of the method, setting the preset value includes setting a null value for the variable.

According to another embodiment of the method, identifying the multiple variables includes computing one or more variables as a value derived from accessed data.

According to another embodiment, the method further includes: separating the subscriber line instances into subsets, each subset including churners and non-churners; and in which building the churn predictor further includes: building a churn predictor having multiple different churn prediction models, each model based on machine learning processing of the subscriber line instances in each separate subset.

According to another embodiment of the method, separating the subscriber line instances into subsets further includes including a ratio of churners and non-churners in each subset.

According to another embodiment of the method, separating the subscriber line instances into subsets further includes including a balanced number of churners and non-churners in each subset.

According to another embodiment of the method, separating the subscriber line instances into subsets further includes assigning all churners to every subset, and assigning each non-churner to only one subset.

In accordance with a particular embodiment there is an article of manufacture including a computer-readable storage medium that stores data, which when accessed, causes a device to perform the method for computing a likelihood that a broadband connection service will be terminated in accordance with any of the embodiments of the method as set forth above.

In accordance with a particular embodiment there is an apparatus including means or other components to perform operations that execute the functions of the method for computing a likelihood that a broadband connection service will be terminated in accordance with any of the embodiments of the method as set forth above.

In accordance with another embodiment there is a system for computing a prediction that a broadband connection service will be terminated, including: a data storage device to store data related to broadband connection information for a subscriber line of a broadband connection provider, including data identifying physical layer broadband connection information; a data processing subsystem to identify in the stored data multiple variables each representing information relevant to churn and to assign values to the variables based on valuation rules for each variable; and a server device configured to execute a prediction subsystem including a machine learning network, the prediction subsystem to generate a subscriber line instance, the instance including the assigned values for the multiple variables; process the subscriber line instance with a churn predictor, including generating a churn likelihood score for the subscriber line instance; and predict churn for the subscriber line instance based on the likelihood score.

According to another embodiment of the system, the multiple variables include metrics that directly or indirectly reflect customer satisfaction with the broadband service connection for the subscriber line.

According to another embodiment of the system, the data processing subsystem is to discretize the multiple variables in accordance with the valuation rules for each variable.

According to another embodiment of the system, the data processing subsystem is to discretize the multiple variables by setting a preset value for any variables for which no data is available for a subscriber line instance.

According to another embodiment of the system, setting the preset value includes setting a null value for the variable.

According to another embodiment of the system, the prediction subsystem is to generate the churn likelihood score by generating a confidence score having a value between an upper and lower bound.

According to another embodiment of the system, the prediction subsystem is to generate the churn likelihood score by generating a vote having a discrete binary value of either zero or one, where a one value is generated for any value that exceeds a threshold, and otherwise a zero value is generated.

According to another embodiment of the system, the data processing subsystem is to compute at least one of the multiple variables as a value derived from accessed data.

According to another embodiment of the system, the prediction subsystem is to process the subscriber line instance with a churn predictor having multiple different churn prediction models, and generating the churn likelihood score is based on each prediction model.

According to another embodiment of the system, the prediction subsystem is to predict churn based on the composite of the likelihood scores by predicting churn based on an average value of the scores.

According to another embodiment of the system, the prediction subsystem is to further select the subscriber line instance for a preventive action category based on predicted churn type.

According to another embodiment of the system, the prediction subsystem is to select the subscriber line instance for the preventive action category including selecting the subscriber line instance based on a multi-class classification system of churners, a clustering classification based on data gathered for multiple subscriber lines, or an expert system.

According to another embodiment of the system, the prediction subsystem is to select the subscriber line instance for the preventive action category by selecting the subscriber line instance for one or more of a connection reset, or a monetary credit.

According to another embodiment of the system, the prediction subsystem is to select the subscriber line instance for the preventive action category by selecting the subscriber line instance for automatic configuration changes to improve connection performance.

According to yet another embodiment, there is a method for computing a prediction that a broadband connection service will be terminated, including: accessing data related to broadband connection information for a subscriber line of a broadband connection provider, including data identifying physical layer broadband connection information; identifying in the accessed data multiple variables each representing information relevant to churn and assigning values to the variables based on valuation rules for each variable; generating a subscriber line instance, the instance including the assigned values for the multiple variables; processing the subscriber line instance with a churn predictor, including generating a churn likelihood score for the subscriber line instance; and predicting churn for the subscriber line instance based on the likelihood score.

According to another embodiment of the method, the multiple variables include metrics that directly or indirectly reflect customer satisfaction with the broadband service connection for the subscriber line.

According to another embodiment of the method, identifying the multiple variables includes discretizing the multiple variables in accordance with the valuation rules for each variable.

According to another embodiment of the method, discretizing the multiple variables further includes setting a preset value for any variables for which no data is available for a subscriber line instance.

According to another embodiment of the method, setting the preset value includes setting a null value for the variable.

According to another embodiment of the method, generating the churn likelihood score includes generating a confidence score having a value between an upper and lower bound.

According to another embodiment of the method, generating the churn likelihood score includes generating a vote having a discrete binary value of either zero or one, where a one value is generated for any value that exceeds a threshold, and otherwise a zero value is generated.

According to another embodiment of the method, identifying the multiple variables includes computing at least one variable as a value derived from accessed data.

According to another embodiment of the method, processing the subscriber line instance includes processing the subscriber line instance with a churn predictor having multiple different churn prediction models, and generating the churn likelihood score is based on each prediction model.

According to another embodiment of the method, predicting churn based on the composite of the likelihood scores includes predicting churn based on an average value of the scores.

According to another embodiment, the method further includes: selecting the subscriber line instance for a preventive action category based on predicted churn type.

According to another embodiment of the method, selecting the subscriber line instance for the preventive action category includes selecting the subscriber line instance based on a multi-class classification system of churners, a clustering classification based on data gathered for multiple subscriber lines, or an expert system.

According to another embodiment of the method, selecting the subscriber line instance for the preventive action category includes selecting the subscriber line instance for one or more of a connection reset, or a monetary credit.

According to another embodiment of the method, selecting the subscriber line instance for the preventive action category includes selecting the subscriber line instance for automatic configuration changes to improve connection performance.

According to a particular embodiment, there is an article of manufacture including a computer-readable storage medium that stores data, which when accessed, causes a device to perform the method for computing a prediction that a broadband connection service will be terminated in accordance with any of the embodiments of the method as set forth above.

In accordance with a particular embodiment there is an apparatus including means or other components to perform operations that execute the functions of the method for computing a prediction that a broadband connection service will be terminated in accordance with any of the embodiments of the method as set forth above.

1.-20. (canceled)

21. A method for computing a likelihood that a broadband connection service will be terminated, comprising:
accessing data identifying broadband connection information including data identifying physical layer broadband connection information, and churn indication, for multiple different subscriber lines of a broadband connection provider;
identifying in the accessed data multiple variables each representing information relevant to churn and assigning values to the multiple variables based on valuation rules for each variable; and
generating subscriber line instances, each subscriber line instance associated with a subscriber line identified in the accessed data, each subscriber line instance including the assigned values for the multiple variables and indicating whether the broadband connection service for the subscriber line is likely to be terminated;
building a churn predictor based on machine learning processing of the subscriber line instances.

22. The method of claim 21, wherein accessing the data identifying the broadband connection information comprises accessing broadband connection metadata.

23. The method of claim 21, wherein the multiple variables comprise metrics that directly or indirectly reflect customer satisfaction with the broadband service connection for the subscriber line.

24. The method of claim 21, wherein accessing the data identifying the broadband connection information comprises measured data about the broadband connection.

25. The method of claim 24, wherein the measured data comprises one or more of connection operational data, connection performance data, or performance of a wireless network connected to the connection.

26. The method of claim 21, wherein accessing the data identifying the broadband connection information comprises accessing measurement data initiated by a user of the subscriber line.

27. The method of claim 21, wherein accessing the data identifying the broadband connection information further comprises accessing measurement data created in response to changing one or more physical link settings for the broadband connection to determine a change to performance.

28. The method of claim 21, wherein accessing the data comprises accessing operational and performance data for broadband connections of the broadband connection provider, as well as accessing one or more of complaint call data, dispatch data, weather data, competitor offers, customer complaints in public forums, neighborhood data, geographic data, and/or user equipment data.

29. The method of claim 21, wherein accessing the data identifying the broadband connection information further comprises
dividing measurement data for a collection period into multiple sub-periods; and
computing a difference between adjacent sub-periods to determine a trend for each of the multiple variables.

30. The method of claim 21, wherein generating the subscriber line instances comprises setting a variable value to an upper or lower limit for subscriber line instances having data with an invalid or extreme value.

31. The method of claim 21, wherein generating the subscriber line instances further comprises classifying churners where broadband connection service was terminated by type of churner, where each type corresponds to a reason why broadband connection service was terminated.

32. The method of claim 21, further comprising segmenting the subscriber line instances based on geographic data or tenure of the subscriber line, wherein building the churn predictor comprises building different churn predictors for each geographic segment or for each tenure segment, and generating the subscriber line instances based on the segmenting.

33.-36. (canceled)

37. The method of claim 21, further comprising:
separating the subscriber line instances into subsets, each subset including churners and non-churners; and wherein building the churn predictor further comprises:
building a churn predictor having multiple different churn prediction models, each model based on machine learning processing of the subscriber line instances in each separate subset.

38. The method of claim 37, wherein separating the subscriber line instances into subsets further comprises including a ratio of churners and non-churners in each subset.

39. The method of claim 38, wherein separating the subscriber line instances into subsets further comprises including a balanced number of churners and non-churners in each subset.

40. The method of claim 37, wherein separating the subscriber line instances into subsets further comprises assigning all churners to every subset, and assigning each non-churner to only one subset.

41.-56. (canceled)

57. A method for computing a prediction that a broadband connection service will be terminated, comprising:
accessing data related to broadband connection information for a subscriber line of a broadband connection provider, including data identifying physical layer broadband connection information;
identifying in the accessed data multiple variables each representing information relevant to churn and assigning values to the variables based on valuation rules for each variable;
generating a subscriber line instance, the instance including the assigned values for the multiple variables;
processing the subscriber line instance with a churn predictor, including generating a churn likelihood score for the subscriber line instance; and
predicting churn for the subscriber line instance based on the likelihood score.

58.-62. (canceled)

63. The method of claim 57, wherein generating the churn likelihood score comprises generating a vote having a discrete binary value of either zero or one, where a one value is generated for any value that exceeds a threshold, and otherwise a zero value is generated.

64. (canceled)

65. The method of claim 57, wherein processing the subscriber line instance comprises processing the subscriber line instance with a churn predictor having multiple different churn prediction models, and generating the churn likelihood score is based on each prediction model.

66. The method of claim 65, wherein predicting churn based on the composite of the likelihood scores comprises predicting churn based on an average value of the scores.

67. The method of claim 65, further comprising selecting the subscriber line instance for a preventive action category based on predicted churn type.

68. The method of claim 67, wherein selecting the subscriber line instance for the preventive action category comprises selecting the subscriber line instance based on a multi-class classification system of churners, a clustering classification based on data gathered for multiple subscriber lines, or an expert system.

69. The method of claim 67, wherein selecting the subscriber line instance for the preventive action category comprises selecting the subscriber line instance for one or more of a connection reset, or a monetary credit.

70. The method of claim 67, wherein selecting the subscriber line instance for the preventive action category comprises selecting the subscriber line instance for automatic configuration changes to improve connection performance.

71. (canceled)

72. (canceled)

73. A system for computing a likelihood that a broadband connection service will be terminated, comprising:
a physical connection monitoring subsystem to access data identifying broadband connection information including data identifying physical layer broadband connection information, and churn indication, for multiple different subscriber lines of a broadband connection provider;
a data processing subsystem executed on a server device to identify in the accessed data multiple variables each representing information relevant to the churn indication and assign values to the multiple variables based on valuation rules for each variable; and
a model building subsystem including a machine learning network executed on a server device to:
generate subscriber line instances, each subscriber line instance associated with a subscriber line identified in the accessed data, each subscriber line instance including the assigned values for the multiple variables and indicating whether the broadband connection service for the subscriber line is likely to be terminated; and
build a churn predictor based on machine learning processing of the subscriber line instances.

74. A system for computing a prediction that a broadband connection service will be terminated, comprising:
a data storage device to store data related to broadband connection information for a subscriber line of a broadband connection provider, including data identifying physical layer broadband connection information;
a data processing subsystem to identify in the stored data multiple variables each representing information relevant to churn and to assign values to the variables based on valuation rules for each variable; and
a server device configured to execute a prediction subsystem including a machine learning network, the prediction subsystem to:
(i) generate a subscriber line instance, the subscriber line instance including the assigned values for the multiple variables;
(ii) process the subscriber line instance with a churn predictor, including generating a churn likelihood score for the subscriber line instance; and
(iii) predict churn for the subscriber line instance based on the likelihood score.
